(19) United States
(12) Patent Application Publication
(10) Pub. No.: US 2024/0034637 A1
(43) Pub. Date: Feb. 1, 2024

(54) ENDOTHERMIC PARTICLES FOR NON-AQUEOUS ELECTROLYTE RECHARGEABLE BATTERY AND NON-AQUEOUS ELECTROLYTE RECHARGEABLE BATTERY

(71) Applicant: SAMSUNG SDI CO., LTD., Yongin-si, Gyeonggi-do (KR)

(72) Inventors: Jinseok BAEK, Yokohama-shi (JP); Tomoyuki FUKATANI, Yokohama-shi (JP)

(21) Appl. No.: 18/193,402

(22) Filed: Mar. 30, 2023

(30) Foreign Application Priority Data
Mar. 30, 2022 (JP) 2022-055779
Mar. 29, 2023 (KR) 10-2023-0041587

(51) Int. Cl. C01F 7/021; H01M 10/054

(52) U.S. Cl. CPC C01F 7/021; H01M 10/054; C01P 2006/12; C01P 2006/32

(57) ABSTRACT

Endothermic particles for a non-aqueous electrolyte rechargeable battery include at least partially modified metal hydroxide particles, wherein an amount of desorbed CH₄ from about 80° C. to about 1400° C. by thermal desorption gas mass spectrometry (TDS-MS) of the metal hydroxide particles is between about 15×10⁻⁶ mol/g and about 3000×10⁻⁶ mol/g, an amount of desorbed CH₃OH from about 80° C. to about 1400° C. by TDS-MS is between about 15×10⁻⁶ mol/g and about 6000×10⁻⁶ mol/g, an amount of desorbed H₂O from about 80° C. to about 200° C. by TDS-MS is between about 30×10⁻⁶ mol/g and about 1500×10⁻⁶ mol/g, and a specific surface area of the metal hydroxide particles calculated by an adsorption isotherm measured by adsorbing water vapor or nitrogen to the metal hydroxide particles is between about 8 m²/g and about 600 m²/g.

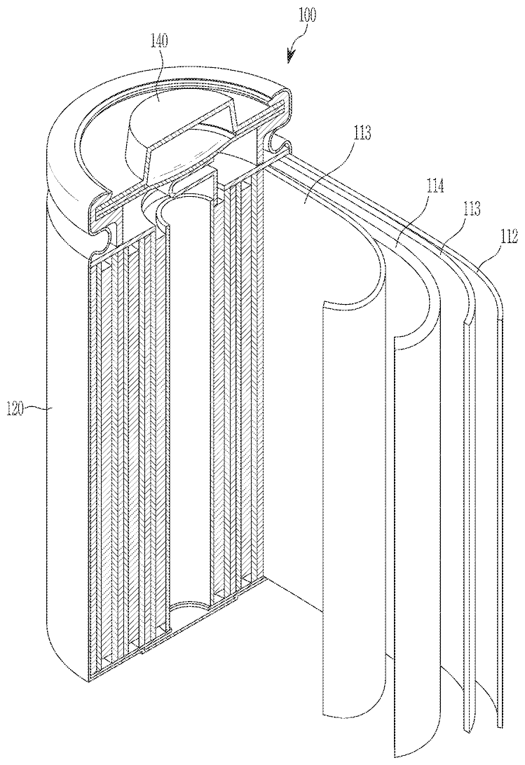

### CROSS-REFERENCE TO RELATED APPLICATION

This application claims priority to and the benefit of Japanese Patent Application No. 2022-055779, filed in the Japan Patent Office on Mar. 30, 2022, and Korean Patent Application No. 10-2023-0041587 filed in the Korean Intellectual Property Office on Mar. 29, 2023, the entire content of each of which is incorporated herein by reference.

### BACKGROUND

### 1. Field

One or more embodiments of the present disclosure relate to endothermic particles for a non-aqueous electrolyte rechargeable battery and a non-aqueous electrolyte rechargeable battery.

### 2. Description of the Related Art

Non-aqueous electrolyte rechargeable batteries including rechargeable lithium ion batteries are widely utilized as power sources for smart phones, notebook computers, and/or the like, and recently are also utilized for large-sized batteries such as those for electric vehicles. The rechargeable lithium ion batteries have advantages of high energy density, but because they utilize non-aqueous electrolytes, sufficient measures are required for safety. However, with the increase in the size of batteries, securing safety has become more important.

For example, when a rechargeable lithium ion battery is placed in a high-temperature environment, there is a possibility that the positive electrode of the rechargeable lithium ion battery generates heat and the internal temperature of the battery rises. When the internal temperature becomes high, a short circuit due to shrinkage of the separator included in the rechargeable lithium ion battery is likely to occur. As a result, there is a possibility that the internal temperature may further rise.

Therefore, in order to ensure the safety of the rechargeable lithium ion battery, it has been proposed to include inorganic particles such as metal hydroxide particles having heat-absorption properties as endothermic particles in the rechargeable lithium ion battery to suppress or reduce an increase in internal temperature.

For example, a first proposal proposes that endothermic and basic inorganic particles having a specific surface area ratio by adsorption of water vapor and nitrogen gas of greater than or equal to about 0.45 and less than or equal to about 2.0 may be included in a separator as endothermic particles to improve battery safety.

A second proposal proposes that endothermic particles having a maximum endothermic peak temperature in DSC of greater than or equal to about 270° C. and less than or equal to about 360° C., and a dehydration reaction temperature range of greater than or equal to about 200° C. and less than or equal to about 400° C. may be included in an electrolyte or separator.

### SUMMARY

However, according to the study of the present inventors, it is known that there are cases where the internal temperature of the non-aqueous electrolyte rechargeable battery cannot be sufficiently suppressed or reduced by the endothermic particles described in the first proposal.

Also, in the temperature ranges described in the second proposal, melting of the separator included in the non-aqueous electrolyte rechargeable battery and decomposition of the charged positive electrode occur.

The present disclosure has been made in view of the above-described problems, and provides endothermic particles capable of suppressing an increase in the internal temperature of a non-aqueous electrolyte rechargeable battery even under an environment in which the internal temperature is likely to increase due to battery abnormalities such as internal short circuits.

As a result of repeated intensive studies by the present inventors to solve the aforementioned problems, in order to suppress or reduce the increase in the internal temperature of the non-aqueous electrolyte rechargeable battery, the present disclosure has been completed only after deriving that it is very important to make a degree of modification of carbon-containing functional groups on the surface of endothermic particles to be contained in non-aqueous electrolyte rechargeable batteries within an appropriate or suitable range.

According to one or more aspects of embodiments of the present disclosure, the endothermic particles for the non-aqueous electrolyte rechargeable battery according to one or more embodiments may include or may be at least partially modified metal hydroxide particles,
wherein an amount of desorbed CH₄ (MS1) from about 80° C. to about 1400° C. by thermal desorption gas mass spectrometry (TDS-MS) of the metal hydroxide particles (i.e., the at least partially modified metal hydroxide particles) is greater than or equal to about 15×10⁻⁶ mol/g and less than or equal to about 3000×10⁻⁶ mol/g,
in the metal hydroxide particles, an amount of desorbed CH₃OH (MS2) from about 80° C. to about 1400° C. by TDS-MS is greater than or equal to about 15×10⁻⁶ mol/g and less than or equal to about 6000×10⁻⁶ mol/g,
in the metal hydroxide particles, an amount of desorbed H₂O (MS3) from about 80° C. to about 200° C. by TDS-MS is greater than or equal to about 30×10⁻⁶ mol/g and less than or equal to about 1500×10⁻⁶ mol/g,
a specific surface area (BET1) of the metal hydroxide particles calculated by an adsorption isotherm measured by adsorbing water vapor is greater than or equal to about 8 m²/g and less than or equal to about 600 m²/g, and
a specific surface area (BET2) of the metal hydroxide particles calculated by an adsorption isotherm measured by adsorbing nitrogen to the metal hydroxide particles is greater than or equal to about 8 m²/g and less than or equal to about 600 m²/g.

According to one or more embodiments of the present disclosure, the endothermic particles for the non-aqueous electrolyte rechargeable battery configured as described above, a degree of modification of carbon-containing functional groups on the surface of the endothermic particles, which is defined not only by the specific surface area but also by the amount of desorption of one or more suitable gases, is set within an appropriate or suitable range and thus when the endothermic particles are included in a non-aqueous electrolyte rechargeable battery, an increase in the internal temperature of non-aqueous electrolyte rechargeable battery may be suppressed or reduced in the event of an abnormality.

In one or more embodiments, a specific surface area ratio (BET1/BET2) of the endothermic particles may satisfy Formula (1).

0.2≤(BET1/BET2)≤4.0 (1)

In one or more embodiments, a desorption gas amount ratio {(MS1+MS2)/MS3} of the endothermic particles may satisfy Formula (2).

1.0≤{(MS1+MS2)/MS3}≤10.0 (2)

In one or more embodiments, an amount of desorbed P₂ (i.e., diphosphorus) of the endothermic particles from about 80° C. to about 1400° C. by TDS-MS may be greater than or equal to about 5×10⁻⁶ mol/g and less than or equal to about 5000×10⁻⁶ mol/g.

In one or more embodiments, an amount of desorbed C₆H₆ of the endothermic particles from about 80° C. to about 1400° C. by TDS-MS may be greater than or equal to about 10×10⁻⁶ mol/g and less than or equal to about 5000×10⁻⁶ mol/g.

In one or more embodiments, the endothermic particles may be modified with a surface treatment agent.

Non-limiting examples of the surface treatment agent may include a silane coupling agent, a titanate-based coupling agent, an aluminate-based coupling agent, a fatty acid surface treatment agent, a phosphonic acid, or a combination thereof.

In one or more embodiments, a maximum endothermic peak temperature in a differential scanning calorimetry of the endothermic particles may be greater than or equal to about 60° C. and less than or equal to about 300° C.

In one or more embodiments, the metal hydroxide particles may include aluminum hydroxide, pseudo-boehmite, boehmite, alumina, kaolinite, or a combination thereof.

According to one or more aspects of embodiments of the present disclosure, a non-aqueous electrolyte rechargeable battery may include the endothermic particles for the non-aqueous electrolyte rechargeable battery in at least one selected from among a positive electrode, a negative electrode, a separator, and a non-aqueous electrolyte in a range of greater than or equal to about 0.01 wt % and less than or equal to about 10.0 wt % based on a total weight, 100 wt %, of the non-aqueous electrolyte rechargeable battery.

According to the present disclosure, the degree of modification by carbon-containing functional groups of endothermic particles is set within an appropriate or suitable range according to the amount of desorption of carbon-containing gas as well as the specific surface area, and thus when included in a non-aqueous electrolyte rechargeable battery, it may suppress or reduce an increase in the internal temperature of the non-aqueous electrolyte rechargeable battery due to a battery abnormality such as an internal short circuit.

In addition, by suppressing the increase in internal temperature, deterioration of the battery caused by the increase in internal temperature may be suppressed or reduced, and as a result, the cycle-life may be improved.

Additional aspects will be set forth in part in the description which follows and, in part, will be apparent from the description, or may be learned by practice of the presented embodiments of the disclosure.

### BRIEF DESCRIPTION OF THE DRAWINGS

The accompanying drawing is included to provide a further understanding of the present disclosure, and is incorporated in and constitutes a part of this specification. The drawing illustrates example embodiments of the present disclosure and, together with the description, serves to explain principles of present disclosure. In the drawing:

The drawing illustrates a schematic view illustrating a non-aqueous electrolyte rechargeable battery according to one or more embodiments of the present disclosure.

### DETAILED DESCRIPTION

The present disclosure may be modified in many alternate forms, and thus specific embodiments will be exemplified in the drawing and described in more detail. It should be understood, however, that it is not intended to limit the present disclosure to the particular forms disclosed, but rather, is intended to cover all modifications, equivalents, and alternatives falling within the spirit and scope of the present disclosure.

Hereinafter, a non-aqueous electrolyte rechargeable battery according to one or more embodiments will be described in more detail.

### 1. Basic Configuration of Non-Aqueous Electrolyte Rechargeable Battery

The non-aqueous electrolyte rechargeable battery according to one or more embodiments of the present disclosure is a rechargeable lithium ion battery including a positive electrode, a negative electrode, a separator, and a non-aqueous electrolyte.

The shape of the rechargeable lithium ion battery is not particularly limited, but may be, for example, a cylindrical shape, a prismatic shape, a laminated shape, or a button shape.

Hereinafter, a non-aqueous electrolyte rechargeable battery according to one or more embodiments will be described with reference to the drawing. The drawing illustrates a schematic view illustrating a non-aqueous electrolyte rechargeable battery according to one or more embodiment of the present disclosure. Referring to the drawing, a rechargeable lithium battery 100 according to one or more embodiments of the present disclosure may include a battery cell including a positive electrode 114, a negative electrode 112 facing the positive electrode 114, a separator 113 between the positive electrode 114 and the negative electrode 112, and a non-aqueous electrolyte for a rechargeable lithium battery impregnating the positive electrode 114, negative electrode 112, and separator 113, a battery case 120 housing the battery cell, and a sealing member 140 sealing the battery case 120.

### 1-1. Positive Electrode

The positive electrode may include a positive electrode current collector and a positive electrode mixture layer formed on the positive electrode current collector.

The positive electrode current collector may be any material as long as it is a conductor, and is, for example, plate-shaped or thin, and may be desirably made of aluminum, stainless steel, nickel coated steel, and/or the like.

The positive electrode mixture layer may include at least a positive electrode active material, and may further include a conductive agent and a positive electrode binder.

The positive electrode active material may be, for example, a transition metal oxide or a solid solution oxide including lithium, and is not particularly limited as long as it may electrochemically intercalate and deintercalate lithium ions. Non-limiting examples of the transition metal oxide including lithium may include Li_{1.0}Ni_{0.88}Co_{0.1}Al_{0.01}Mg_{0.01}O₂, etc. In some embodiments, Li—Co composite oxides such as LiCoO₂ and Li—Ni—Co—Mn-based composite oxides such as LiNiₓCo_{y}Mn_{z}O₂, Li—Ni-based composite oxide such as LiNiO₂, or Li—Mn-based composite oxides such as LiMn₂O₄, and/or the like may be utilized as the positive electrode active material. Non-limiting examples of the solid solution oxide may include LiₐMnₓCo_{y}Ni_{z}O₂ (1.150≤a≤1.430, 0.45≤x≤0.6, 0.10≤y≤0.15, 0.20≤z≤0.28), LiMn_{1.5}Ni_{0.5}O₄. A content (e.g., amount) (e.g., content (e.g., amount) ratio) of the positive electrode active material is not particularly limited, as long as it is applicable to the positive electrode mixture layer of a non-aqueous electrolyte rechargeable battery. Moreover, these compounds may be utilized alone or may be utilized in mixture of plural types (kinds).

The conductive agent is not particularly limited as long as it is for increasing the conductivity of the positive electrode. Non-limiting examples of the conductive agent may include those including at least one selected from among carbon black, natural graphite, artificial graphite, fibrous carbon, and sheet-like carbon.

Non-limiting examples of the carbon black may include furnace black, channel black, thermal black, ketjen black, and/or acetylene black.

Non-limiting examples of the fibrous carbon may include carbon nanotubes and/or carbon nanofibers, and non-limiting examples of the sheet-like carbon may include graphene and/or the like.

A content (e.g., amount) of the conductive agent is not particularly limited, and any content (e.g., amount) applicable to the positive electrode mixture layer of a non-aqueous electrolyte rechargeable battery may be utilized.

The positive electrode binder may include, for example, a fluoro-containing resin such as polyvinylidene fluoride, an ethylene-containing resin such as styrene-butadiene rubber, an ethylene-propylene diene terpolymer, an acrylonitrile-butadiene rubber, a fluoro rubber, polyvinyl acetate, polymethylmethacrylate, polyethylene, polyvinyl alcohol, carboxymethyl cellulose, a carboxymethyl cellulose derivative (a salt of carboxymethyl cellulose, etc.), nitrocellulose, and/or the like. The positive electrode binder may be any material capable of binding the positive electrode active material and the conductive agent onto the positive electrode current collector, and embodiments of the present disclosure are not particularly limited thereto.

### 1-2. Negative Electrode

A negative electrode may include a negative electrode current collector and a negative electrode mixture layer formed on the negative current electrode collector.

The negative electrode current collector may be anything as long as it is a conductor, and may be desirably plate-shaped or thin, and made of copper, stainless steel, nickel-plated steel, and/or the like.

The negative electrode mixture layer may include at least a negative electrode active material, and may further include a conductive agent and a negative electrode binder.

The negative electrode active material is not particularly limited as long as it can electrochemically intercalate and deintercalate lithium ions, but, may be, for example, a graphite active material (artificial graphite, natural graphite, a mixture of artificial graphite and natural graphite, natural graphite coated with artificial graphite), a Si-based active material, or a Sn-based active material (e.g., a mixture of fine particles of silicon (Si) or tin (Sn) or a mixture of oxides thereof and a graphite active material, particulates of silicon or tin, an alloy including silicon or tin as a base material), metallic lithium, a titanium oxide compound such as Li₄Ti₅O₁₂, lithium nitride, and/or the like. As the negative electrode active material, one of the above examples may be utilized, or two or more types (kinds) may be utilized in combination. In one more embodiments, oxides of silicon may be represented by SiOₓ (0<x≤2).

The conductive agent is not particularly limited as long as it is for increasing the conductivity of the negative electrode, and for example, the same conductive agent as described in the positive electrode section may be utilized.

The negative electrode binder may be one capable of binding the negative electrode active material and the conductive agent on the negative electrode current collector, and is not particularly limited. The negative electrode binder may be, for example, polyvinylidene fluoride (PVDF), polytetrafluoroethylene (PTFE), polyacrylic acid (PAA), a styrene-butadiene-based copolymer (SBR), a metal salt of carboxymethyl cellulose (CMC), etc. The binder may be utilized alone or may be utilized in mixture of two or more types (kinds).

### 1-3. Separator

The separator is not particularly limited, and any separator may be utilized as long as it is utilized as a separator for a rechargeable lithium ion battery. The separator may be a porous film, nonwoven fabric, and/or the like that exhibits excellent or suitable high-rate discharge performance alone or in combination. A material (e.g., a resin) constituting the separator may be, for example, a polyolefin-based resin such as polyethylene, polypropylene, etc., a polyester resin such as polyethylene terephthalate, polybutylene terephthalate, etc., polyvinylidene difluoride, a vinylidene difluoride-hexafluoropropylene copolymer, a vinylidene difluoride-perfluorovinyl ether copolymer, a vinylidene difluoride-tetrafluoroethylene copolymer, a vinylidene difluoride-trifluoroethylene copolymer, a vinylidene difluoride-fluoroethylene copolymer, a vinylidene difluoride-hexafluoroacetone copolymer, a vinylidene difluoride-ethylene copolymer, a vinylidene difluoride-propylene copolymer, a vinylidene difluoride-trifluoro propylene copolymer, a vinylidene difluoride-tetrafluoroethylene copolymer, a vinylidene difluoride-ethylene-tetrafluoroethylene copolymer, and/or the like. A porosity of the separator is not particularly limited, and any suitable porosity may be applied to the separator of a suitable rechargeable lithium ion battery.

The separator may further include a surface layer covering the surface of the porous film or non-woven fabric described above. The surface layer may include an adhesive for immobilizing the battery element by adhering to the electrode. Non-limiting examples of the adhesive may include a vinylidene fluoride-hexafluoropropylene copolymer, an acid-modified product of vinylidene fluoride polymers, and/or a styrene-(meth)acrylic acid ester copolymer.

### 1-4. Non-Aqueous Electrolyte

As the non-aqueous electrolyte, a non-aqueous electrolyte that has conventionally been utilized for rechargeable lithium ion batteries may be utilized without particular limitation. The non-aqueous electrolyte has a composition in which an electrolyte salt is included in a non-aqueous solvent, which is a solvent for the electrolyte. Non-limiting examples of the non-aqueous solvent may include cyclic carbonate esters such as propylene carbonate, ethylene carbonate, butylene carbonate, chloroethylene carbonate, fluoroethylene carbonate, and/or vinylene carbonate, cyclic esters such as γ-butyrolactone and/or γ-valerolactone, chain carbonates such as dimethyl carbonate, diethyl carbonate, and/or ethylmethyl carbonate, chain esters such as methylformate, methylacetate, methylbutyrate, ethyl propionate, propyl propionate, ethers such as tetrahydrofuran or a derivative thereof, 1,3-dioxane, 1,4-dioxane, 1,2-dimethoxyethane, 1,4-dibutoxyethane, or methyldiglyme, ethylene glycol monopropyl ether, and/or propylene glycol monopropyl ether, nitriles such as acetonitrile and/or benzonitrile, dioxolane or a derivative thereof, ethylene sulfide, sulfolane, sultone, or a derivative thereof, which may be utilized alone or in a mixture of two or more. When two or more types (kinds) of non-aqueous solvents are mixed and utilized, a mixing ratio of each non-aqueous solvent may be a mixing ratio that may be utilized in a rechargeable lithium ion battery in the art.

Non-limiting examples of the electrolyte salt may include an inorganic ion salt including at least one of lithium (Li), sodium (Na), or potassium (K) such as LiClO₄, LiBF₄, LiAsF₆, LiPF₆, LiPF₆₋ₓ(CₙF₂ₙ₊₁)ₓ [provided that 1<x<6, n=1 or 2], LiSCN, LiBr, Lil, Li₂SO₄, Li₂B₁₀Cl₁₀, NaClO₄, Nal, NaSCN, NaBr, KClO₄, or KSCN, or an organic ion salt such as LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, (CH₃)₄NBF₄, (CH₃)₄NBr, (C₂H₅)₄NClO₄, (C₂H₅)₄NI, (C₃H₇)₄NBr, (n-C₄H₉)₄NClO₄, (n-C₄H₃)₄, (C₂H₅)₄N-maleate, (C₂H₅)₄N-benzoate, (C₂H₅)₄N-phthalate, lithium stearyl sulfonate, lithium octyl sulfonate, lithium dodecylbenzene sulfonate, and/or the like, and it may also utilize these ionic compounds alone or in a mixture of two or more types (kinds). In some embodiments, a concentration of the electrolyte salt may be the same as that of a non-aqueous electrolyte utilized in a rechargeable lithium ion battery in the art, and embodiments of the present disclosure are not particularly limited. In one or more embodiments, a non-aqueous electrolyte containing the above-described lithium compound (electrolyte salt) at a concentration of greater than or equal to about 0.8 mol/L and less than or equal to about 1.5 mol/L may be utilized.

In some embodiments, one or more suitable additives may be added to the non-aqueous electrolyte. Non-limiting examples of such additives may include negative electrode-acting additives, positive electrode-acting additives, ester additives, carbonate ester additives, sulfuric acid ester additives, phosphoric acid ester additives, boric acid ester additives, acid anhydride additives, and/or electrolyte additives. In some embodiments, one of these additives may be added to the non-aqueous electrolyte, in some embodiments, a plurality of types (kinds) of additives may be added.

### 2. Characteristic Configuration of Non-Aqueous Electrolyte Rechargeable Battery According to an Embodiment

Hereinafter, the characteristic configuration of the non-aqueous electrolyte rechargeable battery according to one or more embodiments of the present disclosure will be described in more detail.

The positive electrode mixture layer of the non-aqueous electrolyte rechargeable battery according to one or more embodiments of the present disclosure may include endothermic particles in addition to the aforementioned components.

In one or more embodiments, the endothermic particles may include a metal hydroxide capable of absorbing heat through an endothermic reaction.

The metal hydroxide is not particularly limited as long as it may cause an endothermic reaction, and non-limiting examples thereof may include aluminum hydroxide, pseudo-boehmite, boehmite, alumina, and/or kaolinite. These may be utilized alone or may be utilized together.

In one or more embodiments, an average primary particle diameter of the endothermic particles may be greater than or equal to about 0.05 μm and less than or equal to about 50 μm, or greater than or equal to about 0.1 μm and less than or equal to about 10 μm.

In one or more embodiments, the endothermic particles may be made of metal hydroxide particles at least partially modified by carbon-containing functional groups, and a specific surface area and degree of modification by carbon-containing functional groups of the endothermic particles may be within the following ranges.

The specific surface area (referred to as BET1) calculated from the adsorption isotherm measured by adsorbing water vapor to the endothermic particles may be greater than or equal to about 8 m²/g and less than or equal to about 600 m²/g, and concurrently (e.g., at the same time) the specific surface area (referred to as BET2) calculated from the adsorption isotherm measured by adsorbing nitrogen to the metal hydroxide particles may be greater than or equal to about 8 m²/g and less than or equal to about 600 m²/g.

In one or mor embodiments, the BET1 may be greater than or equal to about 10 m²/g and less than or equal to about 400 m²/g, or greater than or equal to about 12 m²/g and less than or equal to about 210 m²/g.

In one or more embodiments, the BET2 may be greater than or equal to about 9 m²/g and less than or equal to about 400 m²/g, or greater than or equal to about 10 m²/g and less than or equal to about 200 m²/g.

In one more embodiments, a specific surface area ratio (BET1/BET2), which is the ratio between BET1 and BET2, may be greater than or equal to about 0.2 and less than or equal to about 4.0, or greater than or equal to about 1.0 and less than or equal to about 3.5.

In one or more embodiments, the carbon-containing functional group may be mainly a CH₃ group and/or a CH₂OH group. The degree of modification by the carbon-containing functional groups may be defined by an amount (desorption amount) of gas desorbed from the endothermic particles when the endothermic particles are heated from about 80° C. to about 1400° C., and the desorption amount of the following one or more suitable gases derived from the above-mentioned functional group may satisfy the following range.

In one or more embodiments, the amount of desorbed CH4 (referred to as MS1) may be greater than or equal to about 15×10⁻⁶ mol/g and less than or equal to about 3000×10⁻⁶ mol/g; the amount of desorbed CH₃OH (referred to as MS2) may be greater than or equal to about 15×10⁻⁶ mol/g and less than or equal to about 6000×10⁻⁶ mol/g (for example, greater than or equal to about 50×10⁻⁶ mol/g and less than or equal to about 6000×10⁻⁶ mol/g); and the amount of desorbed H₂O (referred to as MS3) may be greater than or equal to about 30×10⁻⁶ mol/g and less than or equal to about 1500×10⁻⁶ mol/g.

In one or more embodiments, the MS1 may be greater than or equal to about 20×10⁻⁶ mol/g or greater than or equal to about 30×10⁻⁶ mol/g.

In one or more embodiments, the MS2 may be greater than or equal to about 100×10⁻⁶ mol/g, or greater than or equal to about 200×10⁻⁶ mol/g.

In one or more embodiments, the MS3 may be greater than or equal to about 50×10⁻⁶ mol/g and less than or equal to about 1000×10⁻⁶ mol/g, or greater than or equal to about 100×10⁻⁶ mol/g and less than or equal to about 750×10⁻⁶ mol/g.

Further, in one or more embodiments, a ratio of these desorbed amounts {(MS1+MS2)/MS3} may be greater than or equal to about 1.0 and less than or equal to about greater than or equal to about 2.0 and less than or equal to about 9.0, or greater than or equal to about 2.5 and less than or equal to about 8.0.

In one or more embodiments, when the endothermic particles are modified with phosphonic acid, a fire extinguishing function may be imparted to the endothermic particles.

Therefore, the amount of desorbed P₂ (referred to as MS4) from about 80° C. to about 1400° C. by TDS-MS of the endothermic particles may be greater than or equal to about 5×10⁻⁶ mol/g and less than or equal to about 5000×10⁻⁶ mol/g, greater than or equal to about 20×10⁻⁶ mol/g and less than or equal to about 3000×10⁻⁶ mol/g, or greater than or equal to about 40×10⁻⁶ mol/g and less than or equal to about 1000×10⁻⁶ mol/g.

Further, in one or more embodiments, when the endothermic particles are modified with a functional group containing a phenyl group, it is easy to disperse the metal hydroxide particles in a solvent when preparing a slurry such as a positive electrode mixture slurry.

Therefore, the amount of desorbed C₆H₆ (referred to as MS5) about 80° C. to about 1400° C. by TDS-MS of the endothermic particles may be greater than or equal to about 10×10⁻⁶ mol/g and less than or equal to about 5000×10⁻⁶ mol/g, greater than or equal to about 20×10⁻⁶ mol/g and less than or equal to about 3000×10⁻⁶ mol/g, or greater than or equal to about 40×10⁻⁶ mol/g and less than or equal to about 1500×10⁻⁶ mol/g.

In one or more embodiments, the total content (e.g., amount) of the modifying molecules contained in the endothermic particles may be in the range of greater than or equal to about 10 wt % and less than or equal to about 90 wt %, greater than or equal to about 20 wt % and less than or equal to about 80 wt %, or greater than or equal to about 30 wt % and less than or equal to about 70 wt %, when the total amount of the endothermic particles is 100 wt %.

In one or more embodiments, the content (e.g., amount) of endothermic particles for a non-aqueous electrolyte rechargeable battery in the positive electrode mixture layer may be in the range of greater than or equal to about 0.05 wt % and less than or equal to about 10.0 wt %, greater than or equal to about 0.1 wt % and less than or equal to about 5.0 wt %, or greater than or equal to about 0.5 wt % and less than or equal to about 2.0 wt % based on the total weight, 100 wt %, of the positive electrode mixture layer.

In one or more embodiment, the content (e.g., amount) of the endothermic particles for the non-aqueous electrolyte rechargeable battery based on the total weight of the non-aqueous electrolyte rechargeable battery may be different depending on the utilization of the non-aqueous electrolyte rechargeable battery and thus is not limited to the following range. However, for example, in some embodiments, the content (e.g., amount) of endothermic particles for the non-aqueous electrolyte rechargeable battery included in the non-aqueous electrolyte rechargeable battery may be in the range of greater than or equal to about 0.01 wt % and less than or equal to about 10.0 wt %, greater than or equal to about 0.01 wt % and less than or equal to about 5.0 wt %, greater than or equal to about 0.02 wt % and less than or equal to about 2.0 wt %, or greater than or equal to about 0.1 wt % and less than or equal to about 0.5 wt % based on the total weight, 100 wt %, of the non-aqueous electrolyte rechargeable battery.

### 3. Manufacturing Method of Non-Aqueous Electrolyte Rechargeable Battery According to an Embodiment

Hereinafter, a manufacturing method of a rechargeable lithium ion battery is described in more detail.

The endothermic particles for the non-aqueous electrolyte rechargeable battery according to one or more embodiments of the present disclosure may be produced by modifying metal hydroxide particles made of metal hydroxide.

Non-limiting examples of the method for modifying the metal hydroxide particles may include a method of immersing the metal hydroxide particles in a modifier (e.g., a surface modifier or surface treatment agent) for a set or predetermined period of time.

Non-limiting examples of the surface modifier may include a silane coupling agent, a titanate coupling agent, an aluminate coupling agent, a fatty acid surface treatment agent (for example, higher fatty acid surface treatment agent having C10 to C60 carbon atoms), and/or phosphonic acid (such as phosphonic acid and phenylphosphonic acid).

By immersing the metal hydroxide particles in these modifiers, the surface and inside of the metal hydroxide particles are modified with functional groups derived from these modifiers.

In one or more embodiments, the positive electrode may be produced as follows. First, a positive electrode slurry may be formed by dispersing a mixture of a positive electrode active material, a conductive agent, a positive electrode binder, and endothermic particles for a non-aqueous electrolyte rechargeable battery in a desired or suitable ratio in a solvent for a positive electrode slurry. Next, this positive electrode slurry is coated on the positive electrode current collector and dried to form a positive electrode mixture layer. The coating method of the present disclosure is not particularly limited thereto. In one or more embodiments, the coating method may include a knife coater method, a gravure coater method, a reverse roll coater method, a slit die coater method, and/or the like. Each of the following coating processes is also performed by the same method. Subsequently, the positive electrode material mixture layer is pressed by a press to have a desired or suitable density. Thus, a positive electrode is manufactured.

The negative electrode may also be produced in substantially the same way as the positive electrode. First, a negative electrode slurry may be prepared by dispersing a mixture of materials constituting the negative electrode mixture layer in a solvent for a negative electrode slurry. Next, a negative electrode mixture layer may be formed by coating the negative electrode slurry on the negative electrode current collector and drying it. Next, the negative electrode material mixture layer may be pressed by a press machine so as to have a desired or suitable density. Thus, a negative electrode is manufactured.

Next, an electrode structure may be manufactured by placing a separator between the positive electrode and the negative electrode. Then, the electrode structure may be processed into a desired or suitable shape (e.g., cylindrical shape, prismatic shape, laminated shape, button shape, etc.) and inserted into a container of the above shape. Subsequently, a non-aqueous electrolyte may be inserted into the corresponding container to impregnate the electrolyte into each pore in the separator or a gap between the positive and negative electrodes. Accordingly, a rechargeable lithium ion battery is manufactured.

### 4. Effect by the Present Embodiment

According to the non-aqueous electrolyte rechargeable battery structured as described above, an increase in the internal temperature of the battery may be sufficiently suppressed or reduced even in an abnormal state. As a result, the safety of the non-aqueous electrolyte rechargeable battery may be ensured, and at the same time, battery characteristics such as cycle life may be maintained high and desirable.

### 5. Another Embodiment

The present disclosure is not limited to the aforementioned embodiments.

In the aforementioned embodiments, the embodiments in which the positive electrode includes the endothermic particles for the non-aqueous electrolyte rechargeable battery according to the present disclosure have been described, but the negative electrode may include the endothermic particles for the non-aqueous electrolyte rechargeable battery, or the separator or electrolyte may include the endothermic particles for the non-aqueous electrolyte rechargeable battery.

In one or more embodiments, when the negative electrode includes the endothermic particles for the non-aqueous electrolyte rechargeable battery, the content (e.g., amount) of the endothermic particles for the non-aqueous electrolyte rechargeable battery with respect to the entire negative electrode may be in substantially the same range as that of the positive electrode. In one or more embodiments, when the separator includes the endothermic particles for the non-aqueous electrolyte rechargeable battery, the content (e.g., amount) of the endothermic particles for the non-aqueous electrolyte rechargeable battery may be greater than or equal to about 0.5 wt % and less than or equal to about 20.0 wt % when the total weight of the separator is 100 wt %. In one or more embodiments, when the electrolyte includes the endothermic particles for the non-aqueous electrolyte rechargeable battery, the content (e.g., amount) of the endothermic particles for the non-aqueous electrolyte rechargeable battery may be in the range of greater than or equal to about 0.1 wt % and less than or equal to about 10.0 wt % when the total weight of the electrolyte is 100 wt %. In one or more embodiments, when the separator or the electrolyte includes the endothermic particles, the average primary particle diameter of the endothermic particles may be greater than or equal to about 0.1 μm and less than or equal to about 10 μm.

In addition, the present disclosure is not limited to these embodiments but may be variously modified without deviating from the purpose.

### EXAMPLES

Hereinafter, the present disclosure will be described in more detail according to specific examples. However, the following examples are merely examples of the present disclosure, and the present disclosure is not limited to the following examples.

### Production of Endothermic Particles for Non-Aqueous Electrolyte Rechargeable Battery

### Example 1

Modified aluminum hydroxide particles (A) were obtained by dissolving 3.0 g of triethoxyvinylsilane in 50 cc (i.e., cubic centimeter) of a mixed solution of ethanol and purified water (a volume mixing ratio of 1:1) to prepare a treatment solution, dispersing 1.0 g of aluminum hydroxide particles (BET1: 205 m²/g, BET2: 200 m²/g, manufactured by Iwatani Chemical Industry Co., Ltd.) in the treatment solution, and then, performing a heat treatment at 80° C. for 4 hours and vacuum-drying. Herein, metal hydroxide particles utilized in each example had an average primary particle diameter of greater than or equal to 5 μm and less than or equal to 12 μm.

### Example 2

Modified activated alumina particles (A) were obtained by dissolving 3.0 g of triethoxyvinylsilane in 50 cc of a mixed solution of ethanol and purified water (a volume mixing ratio of 1:1) to prepare a treatment solution, dispersing 1.0 g of activated alumina particles (BET1: 300 m²/g, BET2: 270 m²/g, manufactured by Iwatani Chemical Industry Co., Ltd.) in the treatment solution, and then, performing a heat treatment at 80° C. for 4 hours and vacuum-drying.

### Example 3

Modified pseudo-boehmite particles (A) were obtained in substantially the same manner as in Example 1 except that 1.0 g of pseudo-boehmite particles (BET1: 407 m²/g, BET2: 377 m²/g, manufactured by CIS Chemical Co., Ltd.) were dispersed in a treatment solution prepared by dissolving 3.0 g of p-styryltrimethoxysilane in 50 cc of a mixed solution of ethanol and purified water (a volume mixing ratio of 1:1).

### Example 4

Modified magnesium hydroxide particles (A) were obtained in substantially the same manner as in Example 1 except that 1.0 g of magnesium hydroxide particles (BET1: 160 m²/g, BET2: 150 m²/g, manufactured by Iwatani Chemical Industry Co., Ltd.) were dispersed in a treatment solution prepared by dissolving 3.0 g of 3-acryloxypropyltrimethoxysilane in 50 cc of a mixed solution of ethanol and purified water (a volume mixing ratio of 1:1).

### Example 5

Modified kaolinite particles (A) were obtained in substantially the same manner as in Example 1 except that 1.0 g of kaolinite particles (Al₂Si₂O₅(OH)₄, BET1: 120 m²/g, BET2: 110 m²/g) were dispersed in a treatment solution prepared by dissolving 3.0 g of 3-aminopropyltrimethoxysilane in 50 cc of a mixed solution of ethanol and purified water (a volume mixing ratio of 1:1).

### Example 6

Modified pseudo-boehmite particles (B) were obtained in substantially the same manner as in Example 1 except that 1.0 g of pseudo-boehmite particles (BET1: 407 m²/g, BET2: 377 m²/g, manufactured by CIS Chemical Co., Ltd.) were dispersed in a treatment solution prepared by dissolving 0.3 g of p-styryltrimethoxysilane in 50 cc of a mixed solution of ethanol and purified water (a volume mixing ratio of 1:1).

### Example 7

Modified pseudo-boehmite particles (C) were obtained in substantially the same manner as in Example 1 except that 1.0 g of pseudo-boehmite particles (BET1: 407 m²/g, BET2: 377 m²/g, manufactured by CIS Chemical Co., Ltd.) were dispersed in a treatment solution prepared by dissolving 3.0 g of isopropyltriisostearoyltitanate in 50 cc of a mixed solution of ethanol and purified water (a volume mixing ratio of 1:1).

### Example 8

Modified pseudo-boehmite particles (D) were obtained in substantially the same manner as in Example 1 except that 1.0 g of pseudo-boehmite particles (BET1: 407 m²/g, BET2: 377 m²/g, manufactured by CIS Chemical Co., Ltd.) were dispersed in a treatment solution prepared by dissolving 3.0 g of sodium stearate in 50 cc of a mixed solution of ethanol and purified water (a volume mixing ratio of 1:1).

### Example 9

Modified pseudo-boehmite particles (E) were obtained in substantially the same manner as in Example 1 except that 1.0 g of pseudo-boehmite particles (BET1: 407 m²/g, BET2: 377 m²/g, manufactured by CIS Chemical Co., Ltd.) were dispersed in a treatment solution prepared by dissolving 5.0 g of phenylphosphonic acid in 50 cc of a mixed solution of ethanol and purified water (a volume mixing ratio of 1:1).

### Example 10

Modified pseudo-boehmite particles (F) were obtained in substantially the same manner as in Example 1 except that 1.0 g of pseudo-boehmite particles (BET1: 407 m²/g, BET2: 377 m²/g, manufactured by CIS Chemical Co., Ltd.) were dispersed in a treatment solution prepared by dissolving 3.0 g of phenylphosphonic acid in 50 cc of a mixed solution of ethanol and purified water (a volume mixing ratio of 1:1).

### Comparative Examples 2 to 8

Endothermic particles described in Table 1 was used.

TABLE 1

| | Endothermic | Sample name, Manufacturer |
|---|---|---|
| | particles | |
| Comparative | aluminum hydroxide | RA-40, Iwatani Chemical Industry |
| Example 2 | particles 1 | Co., Ltd. |
| Comparative | aluminum hydroxide | RH40, Iwatani Chemical Industry |
| Example 3 | particles 2 | Co., Ltd. |
| Comparative | magnesium | ECOMAG ™Z-10, Tateho Chemical |
| Example 4 | hydroxide particles 1 | Industries Co., Ltd. |
| Comparative | magnesium | MTK-30, Iwatani Chemical Industry |
| Example 5 | hydroxide particles 2 | Co., Ltd. |
| Comparative | kaolinite particles | Kaolinite, Sigma-Aldrich Chemical |
| Example 6 | | |
| Comparative | pseudo-boehmite | PB-R, CIS Chemical Co., Ltd. |
| Example 7 | particles | |
| Comparative | boehmite particles | BG-601, Anhui Estone Materials |
| Example 8 | | Technology Co., Ltd. |

### Examples 11 to 13

Modified pseudo-boehmite particles (G) were obtained in substantially the same manner as in Example 1 except that 1.0 g of pseudo-boehmite particles (BET1: 407 m²/g, BET2: 377 m²/g, manufactured by CIS Chemical Co., Ltd.) were dispersed in a treatment solution prepared by dissolving 1.0 g of phenylphosphonic acid in 50 cc of a mixed solution of ethanol and purified water (a volume mixing ratio of 1:1).

### Comparative Example 9

Modified aluminum hydroxide particles (B) were obtained in substantially the same manner as in Example 1 except that 1.0 g of aluminum hydroxide particles (BET1: 3.3 m²/g, BET2: 3.2 m²/g, manufactured by Iwatani Chemical Industry Co., Ltd.) were dispersed in a treatment solution prepared by dissolving 3.0 g of p-styryltrimethoxysilane in 50 cc of a mixed solution of ethanol and purified water (a volume mixing ratio of 1:1).

### Comparative Example 10

Modified magnesium hydroxide particles (B) were obtained in substantially the same manner as in Example 1 except that 1.0 g of magnesium hydroxide particles (BET1: 2.0 m²/g, BET2: 2.4 m²/g, manufactured by Iwatani Chemical Industry Co., Ltd.) were dispersed in a treatment solution prepared by dissolving 3.0 g of p-styryltrimethoxysilane in 50 cc of a mixed solution of ethanol and purified water (a volume mixing ratio of 1:1).

### Comparative Example 11

Modified boehmite particles (B) were obtained in substantially the same manner as in Example 1 except that 1.0 g of boehmite particles (BET1: 15.2 m²/g, BET2: 10.1 m²/g) were dispersed in a treatment solution prepared by dissolving 3.0 g of p-styryltrimethoxysilane in 50 cc of a mixed solution of ethanol and purified water (a volume mixing ratio of 1:1).

### Comparative Example 12

Surface-modified pseudo-boehmite particles (H) were obtained in substantially the same manner as in Example 1 except that 1.0 g of pseudo-boehmite particles (BET1: 407 m²/g, BET2: 377 m²/g, manufactured by CIS Chemical Co., Ltd.) were dispersed in a treatment solution prepared by dissolving 0.05 g of phenylphosphonic acid in 50 cc of a mixed solution of ethanol and purified water (a volume mixing ratio of 1:1).

### Manufacture of Positive Electrode

### Examples 1 to 10 and Comparative Examples 2 to 12

LiCoO₂, acetylene black, polyvinylidene fluoride, and each of the corresponding endothermic particles for a non-aqueous electrolyte rechargeable battery shown in Table 2 in a weight ratio of 97.0:1.0:1.3:0.7 were mixed and dispersed in an N-methyl-2-pyrrolidone solvent, preparing a positive electrode mixture slurry. Subsequently, the positive electrode mixture slurry was coated and dried on one surface or both (e.g., simultaneously) surfaces of an aluminum current collector foil to have a coating amount of the mixture (surface density) of 20.0 mg/cm² per each surface after the drying and then, pressed with a roll press to have a mixture layer density of 4.15 g/cc, manufacturing each positive electrode.

### Examples 11 to 13 and Comparative Example 1

Each positive electrode was manufactured in substantially the same manner as in Example 1 except that the positive electrode mixture slurry was prepared by mixing and dispersing LiCoO₂, acetylene black, and polyvinylidene fluoride in a weight ratio of 97.7:1.0:1.3 in the N-methyl-2-pyrrolidone solvent.

### Manufacture of Negative Electrode

### Examples 1 to 10 and 12 to 13 and Comparative Examples 1 to 12

Artificial graphite, a carboxylmethyl cellulose (CMC) sodium salt, and a styrene butadiene-based aqueous dispersed body in a weight ratio of 97.5:1.0:1.5 were dissolved and dispersed in a water solvent, preparing a negative electrode mixture slurry. Subsequently, the negative electrode mixture slurry was coated and dried on one surface or both (e.g., simultaneously) surfaces of a copper foil to have a coating amount of the mixture (surface density) of 10.5 mg/cm² per one surface after the drying and then, pressed with a roll press to have the mixture layer density of 1.65 g/cc, manufacturing a negative electrode.

### Example 11

A negative electrode was manufactured in substantially the same manner as in Example 1 except that the negative electrode mixture slurry was prepared by dissolving and dispersing artificial graphite, a carboxylmethyl cellulose (CMC) sodium salt, a styrene butadiene-based aqueous dispersed body, and the endothermic particles for a non-aqueous electrolyte rechargeable battery shown in Table 2 in a weight ratio of 96.5:1.0:1.5:1.0 in a water solvent.

### Manufacture of Rechargeable Battery Cells

### Examples 1 to 11 and Comparative Examples 1 to 12

A plurality of the positive electrodes and a plurality of the negative electrode were stacked with a polypropylene porous separator between the positive and negative electrodes to have battery design capacity of 300 mAh, manufacturing an electrode stack. Subsequently, a rechargeable battery cell before the initial charge was manufactured by welding nickel and aluminum lead wires respectively to the negative and positive electrodes of the electrode stack, housing the electrode stack in an aluminum laminate film with the lead wires externally pulled out, injecting an electrolyte thereinto, and sealing the aluminum laminate film under a reduced pressure. The electrolyte was prepared by dissolving 1.3 M LiPF₆ and 1 wt % of vinylene carbonate in a mixed solvent of ethylenecarbonate/dimethylcarbonate/fluoroethylenecarbonate in a volume ratio of 15/80/5.

### Example 12

30 parts by weight of the pseudo-boehmite particles (G) and 0.3 parts by weight of an ammonia polycarboxylic acid aqueous solution were mixed in 100 parts by weight of ion exchanged water and then, treated with bead mills to adjust an average particle diameter (D50) into 1.0 μm or less, preparing a substantially uniform composition for forming an endothermic layer.

Subsequently, a rechargeable battery cell was manufactured in substantially the

same manner as in Example 1 except that a separator containing an endothermic layer was manufactured by applying the composition for forming an endothermic layer on the aforementioned polypropylene porous separator with a micro gravure coater and drying it at 80° C. to remove the ion exchanged water to form a 2 μm-thick surface layer including the pseudo-boehmite particles (G) on the polypropylene porous separator. On the other hand, a content (e.g., amount) of the endothermic particles included in the separator was 30 wt % based on a total amount of the separator.

### Example 13

A rechargeable battery cell was manufactured in substantially the same manner as in Example 1 except that the composition for forming an endothermic layer was prepared by utilizing 5 parts by weight of the pseudo-boehmite particles (G) based on 100 parts by weight of a non-aqueous electrolyte with the same composition.

### Evaluation of Physical Properties of Endothermic Particles

The endothermic particles for a non-aqueous electrolyte rechargeable battery utilized in the examples and the comparative examples were evaluated as follows.

### Specific Surface Area (BET) of Endothermic Particles

A gas adsorption amount measuring device (BELSORP, Microtrac-Bell Co., Ltd.) was utilized to measure a specific surface area of each endothermic particle (BET (BET1 or BET2), which is a specific surface area calculated by an adsorption isotherm measured by adsorbing water vapor or nitrogen) according to JIS K6217-2.

### Maximum Endothermic Peak of Endothermic Particles

Each of the endothermic particles was measured with respect to a maximum endothermic peak temperature by utilizing a differential scanning calorimetry device (DSC, Hitachi High-Tech Co., Ltd.) and increasing a temperature at 5 K/min according to JIS K7121. According to the embodiments, a maximum endothermic peak temperature of the endothermic particles is greater than or equal to about 60° C. and less than or equal to about 300° C., for example, greater than or equal to about 120° C. and less than or equal to about 200° C., or greater than or equal to about 130° C. and less than or equal to about 175° C.

### Mass of Desorbed Gas of Endothermic Particles

Thermal desorption gas mass spectrometry (TDS-MS) was conducted by utilizing a thermal desorption gas mass spectrometer (TDS-1200, ESCO, Ltd.) to measure and analyze each desorbed amount of methane molecules, methanol molecules, benzene molecules, diphosphorus molecules, and water molecules, as follows.

In TDS, the endothermic particles were set by utilizing a sample stage made of quartz and a sample dish made of SiC. In addition, the temperature increase rate was 60° C./min. The temperature increase was controlled or selected by monitoring a temperature on the sample surface. Furthermore, a weight of the sample was 1 mg, which was corrected by an actual weight. A quadruple mass spectrometer was utilized for a detection, and a voltage applied thereto was 1000 V.

TDS was utilized to measure an amount (μmol/g, i.e., 10⁻⁶ mol/g) of each gas desorbed from the endothermic particles during the temperature increase from 80° C. to 1400° C. The mass number [M/z] utilized for analyzing the measurements was 15 for CH₄, 18 for H₂O, 31 for CH₃OH, 62 for P₂, and 78 for C₆H₆, wherein gases corresponding to the mass numbers were all each of the aforementioned substances. Herein, regarding the gas amount of H₂O, an integrated value only from 80° C. to 200° C. out of the entire temperature range was utilized to obtain the desorbed H₂O amuont (MS3).

### Confirmation of Heat Generation at 150° C. or Less Under Coexistence of Endothermic Particles and Electrolyte

After putting 2.0 mg of the endothermic particles and 0.5 mg of the same electrolyte as utilized to manufacture the rechargeable battery cells into a dedicated airtight container and caulking it, whether or not an exothermic peak was found at 150° C. or less was examined by checking an endothermic peak in substantially the same method as the aforementioned method of measuring the maximum endothermic peak of the endothermic particles, wherein Comparative Examples 1 to 11 exhibited a clear exothermic peak around 100° C., but Examples 1 to 13 exhibited no exothermic peak.

### Evaluation of Rechargeable Battery Cells Cycle Characteristics

The rechargeable battery cells according to Examples 1 to 13 and Comparative Examples 1 to 12 were each charged under a constant current to 4.3 Vat 0.1 CA of design capacity and charged under a constant voltage to 0.05 CA still at 4.3 V in a 25° C. thermostat. Subsequently, the battery cells were each discharged under a constant current to 3.0 V at 0.1 CA. In addition, the battery cells were each measured with respect to initial discharge capacity after the 1^{st} cycle through a constant current charge at 0.2 CA, a constant voltage charge at 0.05 CA, and a constant current discharge at 0.2 CA under conditions of a charge cut-off voltage of 4.3 V and a discharge cut-off voltage of 3.0 V in the 25° C. thermostat. The rechargeable battery cells were each 100 cycles charged and discharged through a constant current charge at 0.5 CA, a constant voltage charge at CA, and a constant current discharge at 0.5 CA under conditions of a charge cut-off voltage of 4.3 V and a discharge cut-off voltage of 3.0 V at 45° C. to test a cycle-life. After the 100 cycles, discharge capacity at a constant current charge of 0.2 CA, a constant voltage charge of 0.05 CA, and a constant current discharge of 0.2 CA of each of the battery cells was measured and was divided by the initial discharge capacity to obtain capacity retention after the 100 cycles.

### Heating Test

The rechargeable battery cells according to Examples 1 to 13 and Comparative Examples 1 to 12 were each charged under a constant current to 4.42 V at design capacity of 0.1 CA and charged under a constant voltage at 4.42 V to 0.05 CA in the 25° C. thermostat. Subsequently, the battery cells were each discharged to 3.0 V at 0.1 CA under a constant current. In addition, in the 25° C. thermostat, after performing a constant current charge at 0.2 CA, a constant voltage charge at 0.05 CA, and a constant current discharge at 0.2 CA under conditions of a charge cut-off voltage of 4.42 V and a discharge cut-off voltage of 3.0 V as 1 cycle, the battery cells were each charged again under a constant current/constant voltage to 4.42 V, which were regarded as initial cells. These rechargeable battery cells were left for 1 hour in a thermostat heated to 165° C., and a case where a voltage of a battery cell became 4.3 V or less was regarded as “abnormal occurrence,” and an abnormal occurrence rate was evaluated in the 10 battery tests.

### Nail Penetration Test

A nail penetration test was conducted by penetrating the aforementioned initial cells in the center with a nail (stainless steel or soft iron) having a diameter of 3 mm at 50 mm/s. A case where an external temperature of a battery cell reached 50° C. or higher 5 seconds after penetrated with the nail was regarded as “abnormal occurrence,” and an abnormal occurrence rate was evaluated in the 10 battery tests.

### Overcharge Test

A case where an external temperature of a battery cell reached 50° C. or higher after additionally charging the aforementioned initial cells under a constant current to 12 V at 3 CA and then, charging them under a constant voltage for 10 minutes after reaching 12 V was regarded as “abnormal occurrence,” an abnormal occurrence rate was evaluated in the 10 battery tests.

### Experiment Results

Table 2 shows types (kinds), physical properties, and locations of the endothermic particles utilized in the examples and the comparative examples described above.

In addition, the evaluation results of Examples 1 to 13 and Comparative Examples 1 to 12 are shown in Table 3.

TABLE 2

| | | Thermal desorption gas mass | | | | | | Specific surface area | | | Maximum | |
|---|---|---|---|---|---|---|---|---|---|---|---|---|
| | | | | | Desorption | | | | | Specific | endothermic | Location |
| | | MS1 | MS2 | MS3 | gas amount | MS4 | MS5 | | | surface | peak | including |
| | Endothermic | (μmol/ | (μmol/ | (μmol/ | ratio | (μmol/ | (μmol/ | BET1 | BET2 | area | temperature | endothermic |
| | particles | g) | g) | g) | (—) | g) | g) | (m²/g) | (m²/g) | ratio | (° C.) | particles |
| Ex. 1 | modified | 120.2 | 1024.2 | 205.2 | 5.6 | 0.0 | 0.2 | 45.5 | 35.4 | 1.3 | 155 | positive |
| | aluminum | | | | | | | | | | | electrode |
| | hydroxide | | | | | | | | | | | |
| | particle A | | | | | | | | | | | |
| Ex. 2 | modified | 198.1 | 1055.3 | 317.2 | 4.0 | 0.0 | 1345.2 | 71.2 | 53.5 | 1.3 | 175 | positive |
| | active | | | | | | | | | | | electrode |
| | alumina | | | | | | | | | | | |
| | particle A | | | | | | | | | | | |
| Ex. 3 | modified | 205.1 | 1542.5 | 405.1 | 4.3 | 0.0 | 1345.2 | 71.2 | 53.5 | 1.3 | 175 | positive |
| | pseudo- | | | | | | | | | | | electrode |
| | boehmite | | | | | | | | | | | |
| | particle A | | | | | | | | | | | |
| Ex. 4 | modified | 130.2 | 1121.4 | 198.1 | 6.3 | 0.0 | 0.1 | 35.1 | 33.5 | 1.0 | 135 | positive |
| | magnesium | | | | | | | | | | | electrode |
| | hydroxide | | | | | | | | | | | |
| | particle A | | | | | | | | | | | |
| Ex. 5 | modified | 125.1 | 958.5 | 202.6 | 5.3 | 0.0 | 1380.5 | 68.5 | 50.2 | 1.4 | 140 | positive |
| | kaolinite | | | | | | | | | | | electrode |
| | particle A | | | | | | | | | | | |
| Ex. 6 | modified | 30.5 | 324.5 | 102.1 | 3.5 | 0.0 | 124.5 | 207.5 | 190.8 | 1.1 | 150 | positive |
| | pseudo- | | | | | | | | | | | electrode |
| | boehmite | | | | | | | | | | | |
| | particle B | | | | | | | | | | | |
| Ex. 7 | modified | 150.6 | 2012.3 | 270.8 | 8.0 | 0.0 | 0.0 | 48.5 | 45.3 | 1.1 | 140 | positive |
| | pseudo- | | | | | | | | | | | electrode |
| | boehmite | | | | | | | | | | | |
| | particle C | | | | | | | | | | | |
| Ex. 8 | modified | 245.5 | 3120.5 | 480.2 | 7.0 | 0.0 | 0.0 | 42.5 | 43.5 | 1.0 | 130 | positive |
| | pseudo- | | | | | | | | | | | electrode |
| | boehmite | | | | | | | | | | | |
| | particle D | | | | | | | | | | | |
| Ex. 9 | modified | 52.5 | 496.5 | 209.6 | 2.6 | 42.5 | 42.1 | 205.5 | 198.4 | 1.0 | 160 | positive |
| | pseudo- | | | | | | | | | | | electrode |
| | boehmite | | | | | | | | | | | |
| | particle E | | | | | | | | | | | |
| Ex. 10 | modified | 208.8 | 1600.9 | 733.8 | 2.5 | 986.6 | 1473.4 | 66.1 | 50.7 | 1.3 | 160 | positive |
| | pseudo- | | | | | | | | | | | electrode |
| | boehmite | | | | | | | | | | | |
| | particle F | | | | | | | | | | | |
| Ex. 11 | modified | 124.5 | 1151.0 | 318.8 | 4.0 | 482.5 | 1241.5 | 132.5 | 124.5 | 1.1 | 160 | negative |
| | pseudo- | | | | | | | | | | | electrode |
| | boehmite | | | | | | | | | | | |
| | particle G | | | | | | | | | | | |
| Ex. 12 | modified | 124.5 | 1151.0 | 318.8 | 4.0 | 482.5 | 1241.5 | 132.5 | 124.5 | 1.1 | 160 | separator |
| | pseudo- | | | | | | | | | | | |
| | boehmite | | | | | | | | | | | |
| | particle G | | | | | | | | | | | |
| Ex. 13 | modified | 124.5 | 1151.0 | 318.8 | 4.0 | 482.5 | 1241.5 | 132.5 | 124.5 | 1.1 | 160 | electrolyte |
| | pseudo- | | | | | | | | | | | |
| | boehmite | | | | | | | | | | | |
| | particle G | | | | | | | | | | | |
| Comp. | | No addition | | | | | | | | | | |
| Ex. 1 | | | | | | | | | | | | |
| Comp. | aluminum | 1.5 | 0.1 | 8.2 | 0.2 | 0.0 | 0.0 | 3.3 | 3.2 | 1.0 | 275 | positive |
| Ex. 2 | hydroxide | | | | | | | | | | | electrode |
| | particle 1 | | | | | | | | | | | |
| Comp. | aluminum | 6.7 | 5.1 | 1425.2 | 0.01 | 0.0 | 0.0 | 205.0 | 200.0 | 1.0 | 120 | positive |
| Ex. 3 | hydroxide | | | | | | | | | | | electrode |
| | particle 2 | | | | | | | | | | | |
| Comp. | magnesium | 1.8 | 0.1 | 8.9 | 0.2 | 0.0 | 0.0 | 2.0 | 2.4 | 0.8 | 420 | positive |
| Ex. 4 | hydroxide | | | | | | | | | | | electrode |
| | particle 1 | | | | | | | | | | | |
| Comp. | magnesium | 5.8 | 4.6 | 1335.8 | 0.01 | 0.0 | 0.0 | 160.0 | 150.0 | 1.1 | 130 | positive |
| Ex. 5 | hydroxide | | | | | | | | | | | electrode |
| | particle 2 | | | | | | | | | | | |
| Comp. | kaolinite | 3.2 | 0.4 | 15.2 | 0.2 | 0.0 | 0.1 | 11.2 | 8.6 | 1.3 | 510 | positive |
| Ex. 6 | particle | | | | | | | | | | | electrode |
| Comp. | pseudo- | 9.4 | 2.5 | 1885.4 | 0.01 | 0.0 | 0.2 | 407.0 | 377.0 | 1.1 | 102 | positive |
| Ex. 7 | boehmite | | | | | | | | | | | electrode |
| | particle | | | | | | | | | | | |
| Comp. | boehmite | 2.1 | 3.2 | 7.5 | 0.7 | 0.0 | 0.2 | 15.2 | 10.1 | 1.5 | 480 | positive |
| Ex. 8 | particle | | | | | | | | | | | electrode |
| Comp. | modified | 10.1 | 20.1 | 50.2 | 0.6 | 0.0 | 7.5 | 10.2 | 8.9 | 1.1 | 275 | positive |
| Ex. 9 | aluminum | | | | | | | | | | | electrode |
| | hydroxide | | | | | | | | | | | |
| | particle B | | | | | | | | | | | |
| Comp. | modified | 8.8 | 18.5 | 45.3 | 0.6 | 0.0 | 6.8 | 9.5 | 9.0 | 1.1 | 420 | positive |
| Ex. 10 | magnesium | | | | | | | | | | | electrode |
| | hydroxide | | | | | | | | | | | |
| | particle B | | | | | | | | | | | |
| Comp. | modified | 11.1 | 15.5 | 52.1 | 0.5 | 0.0 | 8.1 | 23.5 | 20.1 | 1.2 | 480 | positive |
| Ex. 11 | boehmite | | | | | | | | | | | electrode |
| | particle B | | | | | | | | | | | |
| Comp. | modified | 12.2 | 30.2 | 1625.2 | 0.03 | 2.1 | 3.6 | 350.1 | 281.5 | 1.2 | 104 | positive |
| Ex. 12 | pseudo- | | | | | | | | | | | electrode |
| | boehmite | | | | | | | | | | | |
| | particle H | | | | | | | | | | | |

TABLE 3

| | Heat | | | | |
|---|---|---|---|---|---|
| | Generation | | | | |
| | at 150° C. | | Abnor- | | |
| | or less | | mal | | |
| | under | Discharge | occur- | Abnormal | Abnormal |
| | coexistence | capacity | rence | occurrence | occurrence |
| | of | retention | rate in | rate in nail | rate in |
| | endothermic | after 100 | heating | penetration | overcharge |
| | particles and | cycles | test | test | test |
| | electrolyte | (%) | (%) | (%) | (%) |
| Ex. 1 | None | 90.2 | 0 | 10 | 10 |
| Ex. 2 | None | 90.1 | 0 | 20 | 0 |
| Ex. 3 | None | 90.3 | 0 | 20 | 0 |
| Ex. 4 | None | 90.1 | 0 | 20 | 0 |
| Ex. 5 | None | 90.2 | 0 | 20 | 0 |
| Ex. 6 | None | 90.1 | 0 | 20 | 0 |
| Ex. 7 | None | 90.1 | 0 | 20 | 0 |
| Ex. 8 | None | 90.2 | 0 | 20 | 0 |
| Ex. 9 | None | 90.3 | 0 | 10 | 0 |
| Ex. 10 | None | 90.1 | 0 | 0 | 10 |
| Ex. 11 | None | 90.3 | 0 | 0 | 20 |
| Ex. 12 | None | 90.2 | 0 | 20 | 10 |
| Ex. 13 | None | 90.1 | 10 | 20 | 10 |
| Comp. Ex. 1 | Yes | 90.2 | 100 | 100 | 100 |
| Comp. Ex. 2 | Yes | 88.2 | 90 | 90 | 90 |
| Comp. Ex. 3 | Yes | 86.5 | 80 | 80 | 80 |
| Comp. Ex. 4 | Yes | 88.3 | 90 | 100 | 100 |
| Comp. Ex. 5 | Yes | 86.3 | 80 | 80 | 80 |
| Comp. Ex. 6 | Yes | 88.3 | 90 | 100 | 100 |
| Comp. Ex. 7 | Yes | 86.3 | 80 | 80 | 80 |
| Comp. Ex. 8 | Yes | 88.2 | 90 | 90 | 90 |
| Comp. Ex. 9 | Yes | 88.7 | 80 | 90 | 100 |
| Comp. Ex. 10 | Yes | 88.9 | 80 | 100 | 100 |
| Comp. Ex. 11 | Yes | 89.0 | 80 | 90 | 100 |
| Comp. Ex. 12 | Yes | 87.2 | 70 | 80 | 80 |

### Consideration of Examples and Comparative Examples

Referring to the results of Table 3, the non-aqueous electrolyte rechargeable battery cells according to Examples 1 to 13, compared with the battery cells according to Comparative Examples 1 to 12, were significantly suppressed or reduced from the abnormal occurrence rate under various conditions increasing an internal temperature of the battery cells.

Comparative Examples 3, 5, and 7, although the endothermic particles for a non-aqueous electrolyte rechargeable battery shown in Table 2 had a specific surface area within a desirable range, exhibited an extremely high abnormal occurrence rate, as shown in Table 3, compared with Examples 1 to 13.

Referring to the results, in order to obtain endothermic particles for a non-aqueous electrolyte rechargeable battery having sufficient endothermic performance in a battery at a relatively low temperature of 200° C. or less, a modification degree by carbon-containing functional groups, which was found from an amount of desorbed gas shown in Table 2, as well as a specific surface area should be within a set or predetermined range.

One of the reasons for such results is that when endothermic particles having a high modification degree by carbon-containing functional groups may sufficiently secure an amount of metal hydroxide contributing to an endothermic reaction by suppressing a reaction between the metal hydroxide included in the endothermic particles with an electrolyte at an increased internal temperature of a battery.

Because non-aqueous electrolyte rechargeable batteries capable of exhibiting such performance have not been reported so far, as shown in Table 3, non-aqueous electrolyte rechargeable batteries capable of limiting the aforementioned abnormal occurrence rate to 20% or less and specifically, 10% or less, based on the aforementioned heating test, may be regarded as containing endothermic particles for a non-aqueous electrolyte rechargeable battery according to the present disclosure.

In addition, in the nail penetration test, the non-aqueous electrolyte rechargeable battery cells exhibiting an abnormal occurrence rate of 30% or less and specifically, 20% or less, or in the overcharge test, the non-aqueous electrolyte rechargeable battery cells exhibiting an abnormal occurrence rate of 30% or less and specifically, 20% or less, may also be regarded as containing the endothermic particles for a non-aqueous electrolyte rechargeable battery according to the present disclosure.

In addition, the endothermic particles for a non-aqueous electrolyte rechargeable battery according to Examples 1 to 13 had a relatively large specific surface area and a maximum endothermic peak temperature of less than 200° C. As a result, before an internal temperature of the non-aqueous electrolyte rechargeable battery cells reached 200° C., an endothermic reaction occurred due to the endothermic particles for a non-aqueous electrolyte rechargeable battery, suppressing the internal temperature of a non-aqueous electrolyte rechargeable battery cell including the endothermic particles down to less than 200° C., where the battery is not deteriorated.

Herein, it should be understood that terms such as “comprise(s),” “include(s),” or “have/has” are intended to designate the presence of an embodied feature, number, step, element, or a combination thereof, but it does not preclude the possibility of the presence or addition of one or more other features, numbers, steps, elements, or a combination thereof.

The terminology utilized herein is utilized to describe embodiments only and is not intended to limit the present disclosure. In the present disclosure, although the terms “first,” “second,” etc., may be utilized herein to describe one or more elements, components, regions, and/or layers, these elements, components, regions, and/or layers should not be limited by these terms. These terms are only utilized to distinguish one component from another component.

In present disclosure, the average particle diameter (or size) may be measured by a method well suitable to those skilled in the art, for example, may be measured by a particle size analyzer, for example, HORIBA, LA-950 laser particle size analyzer, or may be measured by a transmission electron microscope (TEM) or a scanning electron microscope (SEM). In some embodiments, it is possible to obtain an average particle diameter value by measuring it utilizing a dynamic light scattering method, performing data analysis, counting the number of particles for each particle size range, and calculating from the data. In some embodiments, the average particle diameter (or size) may be measured by a microscope or a particle size analyzer and may refer to a diameter (D50) of particles having a cumulative volume of 50 volume % in a particle size distribution. D50 refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size. Also, in the present disclosure, when particles are spherical, “diameter” indicates a particle diameter or an average particle diameter, and when the particles are non-spherical, the “diameter” indicates a major axis length or an average major axis length.

Herein, “or” is not to be construed as an exclusive meaning, for example, “A or B” is construed to include A, B, A+B, and/or the like. Further, as used herein, the term “and/or” includes any and all combinations of one or more of the associated listed items. Expressions such as “at least one of,” “one of,” and “selected from,” when preceding a list of elements, modify the entire list of elements and do not modify the individual elements of the list.

As utilized herein, the singular forms “a,” “an,” and “the” are intended to include the plural forms as well, unless the context clearly indicates otherwise. Further, the use of “may” when describing embodiments of the present disclosure may refer to “one or more embodiments of the present disclosure”.

As utilized herein, the terms “substantially,” “about,” and similar terms are used as terms of approximation and not as terms of degree, and are intended to account for the inherent deviations in measured or calculated values that would be recognized by those of ordinary skill in the art.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

While the present disclosure has been described in connection with what is presently considered to be practical example embodiments, it is to be understood that the present disclosure is not limited to the disclosed embodiments. In contrast, it is intended to cover one or more suitable modifications and equivalent arrangements included within the spirit and scope of the appended claims and equivalents thereof.

What is claimed is:

1. An endothermic particle for a non-aqueous electrolyte rechargeable battery, the endothermic particle comprising at least partially modified metal hydroxide particles,
wherein an amount of desorbed CH₄ (MS1) from about 80° C. to about 1400° C. by thermal desorption gas mass spectrometry (TDS-MS) of the at least partially modified metal hydroxide particles is greater than or equal to about 15×10⁻⁶ mol/g and less than or equal to about 3000×10⁻⁶ mol/g,
an amount of desorbed CH₃OH (MS2) from about 80° C. to about 1400° C. by TDS-MS of the at least partially modified metal hydroxide particles is greater than or equal to about 15×10⁻⁶ mol/g and less than or equal to about 6000×10⁻⁶ mol/g, an amount of desorbed H₂O (MS3) from about 80° C. to about 200° C. by TDS-MS of the at least partially modified metal hydroxide particles is greater than or equal to about 30×10⁻⁶ mol/g and less than or equal to about 1500×10⁻⁶ mol/g,
a specific surface area (BET1) of the at least partially modified metal hydroxide particles calculated by an adsorption isotherm measured by adsorbing water vapor to the at least partially modified metal hydroxide particles is greater than or equal to about 8 m²/g and less than or equal to about 600 m²/g, and
a specific surface area (BET2) of the at least partially modified metal hydroxide particles calculated by an adsorption isotherm measured by adsorbing nitrogen to the at least partially modified metal hydroxide particles is greater than or equal to about 8 m²/g and less than or equal to about 600 m²/g.

2. The endothermic particle of claim 1, wherein
a specific surface area ratio (BET1/BET2) of the endothermic particle satisfies (1):
0.2≤(BET1/BET2)≤4.0 (1).

3. The endothermic particle of claim 1, wherein
a desorption gas amount ratio {(MS1+MS2)/MS3} of the endothermic particle satisfies (2):
1.0≤{(MS1+MS2)/MS3}≤10.0 (2).

4. The endothermic particle of claim 1, wherein
an amount of desorbed P₂ of the endothermic particle from about 80° C. to about 1400° C. by TDS-MS is greater than or equal to about 5×10⁻⁶ mol/g and less than or equal to about 5000×10⁻⁶ mol/g.

5. The endothermic particle of claim 1, wherein
an amount of desorbed C₆H₆ of the endothermic particle from about 80° C. to about 1400° C. by TDS-MS is greater than or equal to about 10×10⁻⁶ mol/g and less than or equal to about 5000×10⁻⁶ mol/g.

6. The endothermic particle of claim 1, wherein
the at least partially modified metal hydroxide particles are modified with a surface treatment agent.

7. The endothermic particle of claim 6, wherein
the surface treatment agent comprises a silane coupling agent, a titanate-based coupling agent, an aluminate-based coupling agent, a fatty acid surface treatment agent, a phosphonic acid, or a combination thereof.

8. The endothermic particle of claim 1, wherein
a maximum endothermic peak temperature in a differential scanning calorimetry of the at least partially modified metal hydroxide particles is greater than or equal to about 60° C. and less than or equal to about 300° C.

9. The endothermic particle of claim 1, wherein
the at least partially modified metal hydroxide particles comprise aluminum hydroxide, pseudo-boehmite, boehmite, alumina, kaolinite, or a combination thereof.

10. A non-aqueous electrolyte rechargeable battery, comprising
a positive electrode, a negative electrode, a separator, and a non-aqueous electrolyte,
wherein the positive electrode comprises a plurality of endothermic particles, each being in the form of the endothermic particle of claim 1, the endothermic particles being in a range of greater than or equal to about 0.01 wt % and less than or equal to about 10.0 wt % based on a total weight, 100 wt %, of the non-aqueous electrolyte rechargeable battery.

11. A non-aqueous electrolyte rechargeable battery, comprising
a positive electrode, a negative electrode, a separator, and a non-aqueous electrolyte,
wherein the negative electrode comprises a plurality of endothermic particles, each being in the form of the endothermic particle of claim 1, the endothermic particles being in a range of greater than or equal to about 0.01 wt % and less than or equal to about 10.0 wt % based on a total weight, 100 wt %, of the non-aqueous electrolyte rechargeable battery.

12. A non-aqueous electrolyte rechargeable battery, comprising
a positive electrode, a negative electrode, a separator, and a non-aqueous electrolyte,
wherein the separator comprises a plurality of endothermic particles, each being in the form of the endothermic particle of claim 1, the endothermic particles being in a range of greater than or equal to about 0.01 wt % and less than or equal to about 10.0 wt % based on a total weight, 100 wt %, of the non-aqueous electrolyte rechargeable battery.

13. A non-aqueous electrolyte rechargeable battery, comprising
a positive electrode, a negative electrode, a separator, and a non-aqueous electrolyte,
wherein the non-aqueous electrolyte comprises a plurality of endothermic particles, each being in the form of the endothermic particle of claim 1, the endothermic particles being in a range of greater than or equal to about 0.01 wt % and less than or equal to about 10.0 wt % based on a total weight, 100 wt %, of the non-aqueous electrolyte rechargeable battery.
